(19) United States
(12) Patent Application Publication
(10) Pub. No.: US 2006/0042492 A1
(43) Pub. Date: Mar. 2, 2006

(54) Systems and methods for printing in surfaces

(76) Inventor: Gilbert Garitano, Alameda, CA (US)

Correspondence Address: Medlen & Carroll, LLP, Suite 350, 101 Howard Street, San Francisco, CA, 94105, US

(21) Appl. No.: 11/210,413

(22) Filed: Aug. 24, 2005

Related U.S. Application Data
(60) Provisional application No. 60/603,928, filed on Aug. 24, 2004.

(51) Int. Cl. B41F 33/00

(52) U.S. Cl. 101/483

(57) ABSTRACT

The present invention relates to systems and methods for forming images in surfaces, and to surfaces containing an image. In particular, the present invention provides systems and methods for forming images in decorative surface materials, and decorative surface materials containing an image with novel optical density characteristics.

The present application claims priority to U.S. Provisional Application Ser. No. 60/603,928, filed Aug. 24, 2004, herein incorporated by reference.

### FIELD OF THE INVENTION

The present invention relates to systems and methods for forming images in surfaces, and to surfaces containing an image. In particular, the present invention provides systems and methods for forming images in decorative surface materials, and decorative surface materials containing an image with novel optical density characteristics.

### BACKGROUND OF THE INVENTION

Decorative surface materials are well known in the art, and have achieved nearly ubiquitous commercial and non-commercial use, particularly in the furniture, interior design, construction, craft, and printing industries. Such surface materials are disclosed, for example, in U.S. Pat. No. 6,759,105 to Brooker et al. Many such materials are useful as visible decorative layers in composite materials such as laminates. In decorative laminate materials, a visible decorative surface is bonded, usually via the application of heat and/or pressure, to one or more layers of one or more different materials with desirable properties, such as low cost, strength, durability, and/or high availability. For example, a common decorative laminate product is a composite material that simulates the look and/or feel of solid wood. Such products are in widespread use in articles such as furniture, flooring, decorative wall paneling, interior or exterior vehicle trim, and home decor items. Other common decorative laminate products include composite materials that simulate materials such as marble, stone, metal, and ceramics. Because decorative surface materials, such as the type used in laminates, are typically produced by creating a decorative image within or upon a suitable surface medium, the ability to satisfactorily reproduce the decorative image within or upon the surface medium is of paramount importance, as the quality of the reproduced image is directly related to the aesthetic quality of the final product. Unfortunately, many surface media are resistant to the creation and/or retention of high quality images within or upon them. Thus, the art is in need of systems and methods for adding vivid color and detailed images to decorative surface materials.

### SUMMARY OF THE INVENTION

The present invention relates to systems and methods for forming images in surfaces, and to surfaces containing an image. In particular, the present invention provides systems and methods for forming images in decorative surface materials, and decorative surface materials containing an image with novel optical density characteristics.

In some embodiments, the present invention provides compositions comprising: a) a surface material, and b) a fixed image, wherein the fixed image is formed in the surface material, and wherein the fixed image has a fixed image optical density value within about 1.5 of a corresponding transfer image optical density value. In certain embodiments, the fixed image optical density value is within about 1.0 of the corresponding transfer image optical density value. In other embodiments, fixed image optical density value is within about 0.5 of the corresponding transfer image optical density value. In certain embodiments, the fixed image optical density value is within about 0.3 of the corresponding transfer image optical density value. In additional embodiments, the fixed image optical density value is within about 2.0, 1.8, 1.6, 1.4, 1.2, 1.0, 0.8, 0.6, 0.5, 0.4, 0.3, 0.2, or 0.1 of the corresponding fixed image optical density value (e.g., as measured by a densitometer).

In certain embodiments, the present invention provides compositions comprising: a) a surface material, and b) a fixed image, wherein the fixed image is formed in the surface material, and wherein the fixed image has a fixed image optical density value of at least 0.7. In some embodiments, the fixed image optical density value is at least 0.8. In other embodiments, the fixed image optical density value is at least 1.0. In further embodiments, the fixed image optical density value is at least 0.9, 1.0, 1.2, 1.4, 1.6, 1.8, 2.0, or 2.2 (e.g., when measuring a shade of black in the fixed image).

In some embodiments, the fixed image comprises a dye. In certain embodiments, the fixed image comprises sublimated dye (e.g., sublimation dye that has been sublimated into a material). In particular embodiments, the fixed image comprises a heat sensitive dye. In some embodiments, the fixed image comprises a diffusion dye.

In other embodiments, the fixed image has a visual appearance (e.g., it can be seen by the human eye when light is reflected from it). In particular embodiments, at least a portion of the visual appearance is one or more shades of black. In some embodiments, at least a portion of the visual appearance is one or more shades of red. In certain embodiments, at least a portion of the visual appearance is one or more shades of orange. In further embodiments, at least a portion of the visual appearance is one or more shades of yellow. In other embodiments, at least a portion of said visual appearance is one or more shades of green. In some embodiments, at least a portion of the visual appearance is one or more shades of blue. In yet other embodiments, at least a portion of the visual appearance is one or more shades of violet. In additional embodiments, at least a portion of the visual image is a pattern. In some embodiments, at least a portion of the visual image represents an object (e.g., animal, person, vase, tree, etc.).

In some embodiments, the present invention provides methods for forming an image in a surface material, comprising; a) providing; i) a surface material, and ii) a transfer medium comprising a transfer image; b) applying a coating to the surface material that facilitates image transfer from a transfer medium comprising a transfer image; and c) contacting at least a portion of the surface material with at least a portion of the transfer medium such that a fixed image is formed in the surface material.

In certain embodiments, the contacting is conducted under heat and/or pressure. In particular embodiments, the pressure is at least 5 pounds per square inch (e.g., 8, 10, 15 or 20 pounds of pressure per square inch). In some embodiments, the pressure is at least 30 pounds per square inch (e.g., at least 30, 35, 40, 45, or 50 pounds of pressure per square inch). In other embodiments, the pressure is about 40 pounds per square inch. In certain embodiments, the pressure has a range of 1-250, 10-100, 20-60, 30-50, or 35-45 pounds of pressure.

In some embodiments, the contacting is for a time less than 5 seconds (e.g., 4 seconds, 3 seconds, or 2 seconds). In particular embodiments, the contacting is for a time of less than 10 seconds (e.g., about 9, 8, 7, or 6 seconds). In certain embodiments, the contacting is for a time of less than 20 seconds (e.g., 19, 18, 17, or 16 seconds). In other embodiments, the contacting is for a time of less than one minute. In particular embodiments, the contacting time is in a range from 1 second to 10 minutes, or 6 seconds to 5.0 minutes, or 15 seconds to 3.0 minutes, or 25 seconds to 2.0 minutes, or 35 seconds to 1.5 minutes, or 40 seconds to 1.5 minutes. In some embodiments, the contacting is conducted at a contacting temperature of at least 350 degrees Fahrenheit (e.g., at least 350, . . . 360, . . . 370, . . . 380, . . . 390 . . . 400 . . . 410 . . . 420 degrees Fahrenheit). In other embodiments, the contacting is conducted at a contacting temperature of at least 200 degrees Fahrenheit.

In certain embodiments, the present invention provides methods for heat transfer printing, comprising; a) providing; i) a surface material; ii) a transfer medium comprising a transfer image, and iii) an image transfer device configured for heating and pressing the surface material; b) applying a coating to the surface material that facilitates image transfer from a transfer medium comprising a transfer image; c) heating the surface material with the image transfer device at a temperature of at least 155 degrees Celsius, and d) contacting at least a portion of the surface material with at least a portion of the transfer medium such that a fixed image is formed in the surface material.

In certain embodiments, the present invention provides methods for heat transfer printing, comprising; a) providing; i) a surface material; ii) a transfer medium comprising a transfer image, and iii) an image transfer system configured for heating and pressing the surface material; b) applying a coating to the surface material that facilitates image transfer from a transfer medium comprising a transfer image; c) heating the surface material with the image transfer system at a temperature of at least 155 degrees Celsius, and d) contacting at least a portion of the surface material with at least a portion of the transfer medium such that a fixed image is formed in the surface material.

In certain embodiments, the contacting step is conducted under pressure, wherein the pressure is applied with the image transfer device or system. In some embodiments, the pressure is at least 10 pounds per square inch (e.g., at least 20, 25, 30, 35, 40, 45 pounds per square inch). In certain embodiments, the image transfer device is a heat press (e.g., Geo Knight 994 Combo Press, an 898 Airpro automatic air operated press, or similar device). In some embodiments, the image transfer device is a heat press capable of heating the surface material from at least two sides. In particular embodiments, the image transfer system comprises a conveyor belt and/or heatable rollers (e.g., wherein heating occurs during movement of a material through the rollers).

In certain embodiments, the fixed image has a fixed image optical density value. In some embodiments, the fixed image has a fixed image optical density value within about 1.5 of a corresponding transfer image optical density value. In certain embodiments, the fixed image optical density value is within about 1.0 of the corresponding transfer image optical density value. In other embodiments, fixed image optical density value is within about 0.5 of the corresponding transfer image optical density value. In certain embodiments, the fixed image optical density value is within about 0.3 of the corresponding transfer image optical density value. In additional embodiments, the fixed image optical density value is within about 2.0, 1.8, 1.6, 1.4, 1.2, 1.0, 0.8, 0.6, 0.5, 0.4, 0.3, 0.2, or 0.1 of the corresponding fixed image optical density value (e.g., as measured by a densitometer).

In certain embodiments, the fixed image has a fixed image optical density value of at least 0.7. In some embodiments, the fixed image optical density value is at least 0.8. In other embodiments, the fixed image optical density value is at least 1.0. In further embodiments, the fixed image optical density value is at least 0.9, 1.0, 1.2, 1.4, 1.6, 1.8, 2.0, or 2.2 (e.g., when measuring a shade of black in the fixed image).

In some embodiments, the transfer medium comprises a sheet of paper (e.g., standard printed paper). In other embodiments, the transfer medium comprises high quality ink jet paper (e.g., AcuPlot, Avery Brilliant Color Ink Jet Paper, or Epson Photo Quality Ink Jet Paper).

### DEFINITIONS

To facilitate an understanding of the invention, a number of terms are defined below.

As used herein, the terms “fixed image” and “fixed image formed” in a material, refer to dye or ink that has been transferred into a surface (e.g., heat transferred into a surface material) and that changes the visual appearance of the surface material (e.g., makes it darker, or lighter, changes the color, adds a pattern or representation of an image).

As used herein, the term “optical density” refers to reflected light intensity measurement that can be made, for example, by a densitometer.

As used herein, the term “corresponding transfer image” refers to the dye in the transfer medium that could be used (e.g., in heat transfer printing) to form a fixed image in a surface material. Generally, the corresponding transfer image when compared to a fixed image, is not the actual transfer image used to transfer the image into the surface material (since the transfer image is “spent”), but instead is made by the same method as the actual transfer image used to form the fixed image (e.g., the same digital picture is printed out onto the same type of paper using the same printer, etc).

As used herein, the term “fixed image optical density value” is an optical density value obtained from a fixed image, or a digital picture of a fixed image. This value may be obtained, for example, by using a densitometer or a gray scale.

As used herein, the term “transfer image optical density value” is an optical density value obtained from a transfer image, or a digital picture of a transfer image. This value may be obtained, for example, by using a densitometer or a gray scale.

As used herein, the term “transfer medium” refers to any material that is capable of having a transfer image formed in it (e.g., by an ink jet printer), and that can then transfer this image to a surface material under heat and/or pressure. Examples of transfer media include, but are not limited to, ordinary printer paper, high quality ink-jet paper, and fabric.

As used herein, the term “contacting-temperature” refers to the temperature at which the transfer image is applied to a surface material.

As used herein, the term “coating” refers to any material that is capable of being applied to a surface material, and that facilitates the practice of the present invention.

As used herein, the term “surface material” is any material that is capable of receiving a fixed image by means of the systems and methods of the present invention.

### DESCRIPTION OF THE INVENTION

The following discussion provides a description of certain preferred illustrative embodiments of the present invention and is not intended to limit the scope of the present invention. For convenience, the discussion focuses on the application of the present invention to the process of heat transfer printing of fixed images, using sublimable dyes, into a surface material to which a coating that facilitates image transfer from a transfer medium comprising a transfer image has been applied, but it should be understood that the methods and systems are applicable and intended for use with a wide variety of similar materials. The description is provided in the following sections: I) Forming Fixed Images in Surface Materials; II) Surface Materials; III) Transfer Mediums and Devices; IV) Dyes; V) Printing Devices; and VI) Fixed Image Characteristics.

I. Forming Fixed Images in Surface Materials

As discussed above, the presently claimed invention comprises systems and methods for transferring (e.g., heat transfer printing) images into surface materials. In preferred embodiments, a coating is applied to a surface material prior to the image transfer. In particularly preferred embodiments, the coating comprises a polymer resin such as polyacrylic resin. In some embodiments, the coating comprises any transparent, substantially transparent, or partially transparent material that can be coated on a surface and that can receive sublimation dyes. Heat transfer printing according to the present invention is performed, in some embodiments, by using a heat press. Methods for heat transfer printing using sublimation or other heat activated inks or dyes may be conducted using methods described in U.S. Pat. Nos. 5,246,518, 5,248,363 and 5,302,223 to Hale (incorporated herein by reference in their entireties). The present invention allows for very short image transfer times that allow rapid production (e.g., high throughput production) of products with high optical density images formed in them. The present invention thus provides a solution to the previously unmet need for bright, true, high optical density color image printing in surface materials.

II. Surface Materials

A. Types of Surface Materials

The present invention may be used with any type of surface material that is capable of accepting a coating that facilitates image transfer from a transfer medium comprising a transfer image. In some embodiments of the present invention, the surface material comprises natural fibers (e.g., cotton, wool, silk, etc.). In other embodiments, the surface material comprises synthetic fibers (e.g., nylon, polyester, etc.). In yet other embodiments, the surface material comprises synthetic polymer materials (e.g., plastics). In additional embodiments, the surface material comprises metal. In particularly preferred embodiments, the surface is a laminate material that, once coated and printed into by the methods of the present invention, can be affixed to another material (e.g., wall, furniture, etc.) to enhance the image of the other material. In some embodiments, the laminate material is coated and printed into after it is affixed to the other material.

In preferred embodiments of the present invention, the surface material comprises wood. The types of wood surfaces with which the present invention may be used include, but are not limited to, veneers, plywoods, particle boards, and other products having at least one natural wood surface. The natural wood surfaces of the present invention may be either hardwood species or softwood species. Suitable hardwood species include, but are not limited to, Afromosia, Anegre, Ash, Beech, Birch, Bubinga, Cherry, Chestnut, Cypress, Eucalyptus, Hickory, Koto, Mahogany, Maple, Oak, Pear, Pecan, Poplar, Rose, Sapeli, Teak, Tupelo, and Walnut. Suitable softwood species include, but are not limited to, Pine, Hemlock, Douglas Fir, and Yew.

For reference, the following wood product definitions are provided, as published on the Internet at http://woodmosaic.com/encyclopedia/:

Veneer: A thin sheet of wood ranging in thickness from ⅛″ to 1/100″ (0.3 to 0.02 cm). Depending on the market, the standard thickness is 1/40″ (0.06 cm), although it may vary from species to species.

Plywood: Any combination of veneers, lumber, core, paper or other material joined together with adhesive to make a one piece construction. Plywood can be of any thickness. Standards are ⅛″, ¼″, ½″, ¾″, or 1″ (0.3, 0.6, 1.3, 1.9, or 2.5 cm). Hardwood plywood usually has a face, core and back.

Face: Any sheet of veneer made from various components that is exposed to view. Examples are wall paneling, desk tops, or counter fronts.

Inner Plies: Any piece or sheet of plywood other than the face and back.

Core: The inner ply of any plywood that has a face and back. The core can be made of lumber, particle board, medium density fiber board (MFD) veneer core, paper core, or resin.

Back: Sometimes called backing grade when referring to veneer. The material used on the reverse side of plywood from the face.

Particle Board: A panel of small fibers that are bonded together with adhesive, heat, and pressure.

Component: Individual sheets of veneer, both in width and length, used to make a face.

Layon: “Jointed veneer” pieces forming a made-to-measure panel ready for application to a door or panel. It is produced by trimming the veneer to give it a straight edge so that it can be stitched together so as to create the width necessary to cover the surface, which is to be veneered. A non-limiting variety of matches from a flitch can be employed to create a pattern on the veneer:

Flitch: Any part of a log that is produced for the purpose of cutting veneer.

Random Match: Sheets of veneer joined together with no definite pattern or color.

Center Matched: An even number of veneer pieces from the same flitch, with a definite line in the center, to show a definite pattern.

Butt Matched: Two pieces of veneer joined at the ends to produce a definite pattern.

Balance Match: Two or more pieces of veneer of equal length and width joined together to make a face.

Book Match: Equal pieces of veneer from the same flitch (½ log) joined together to produce a balanced and definite pattern.

Running Match: A face or panel made from components joined together without flipping through the entire flitch.

Slip Match: Pieces of veneer are slipped from the bundle or flitch without flipping.

Blockmottle: A variegated pattern that looks like small blocks as opposed to crossfire or figure.

Cathedral: Grain pattern in the form of a “V” or inverted “V” running the length of the sheet.

Burl: A distortion or unusual growth within a log that results in a blister like grain. Very unusual and expensive. Used primarily for auto dashboards and fine furniture.

Cross Fire (also Figure or Flame): The appearance of shadows or waves that run across the grain of any species. Other terms such as fiddle back and curly also apply.

Flat sliced: Veneer is sliced parallel to the center of the flitch. This results in Cathedral Grain.

Rotary (Peeled): Veneer is peeled from whole log.

Quartered: Veneer is sliced perpendicular to the growth ring. This results in Wild Grain.

Drift Cut: Similar to quarter cut. Normally only cut from large oak logs to achieve a straight grain veneer.

Half Round: Cut on a half round machine to produce a flat cut effect, and to avoid defective or dark heart woods.

Lengthwise Sliced: Cut on a Japanese machine from flat sawn lumber. Used for thicker veneers.

B. Uses of Surface Materials

The present invention contemplates surface materials, with a fixed image, with any shape or texture. Examples of uses of surface materials with a fixed image therein include, but are not limited to, furniture, flooring, wall coverings, decorative trim and moldings, printing paper, stationary, envelopes, crafts, window blinds, vertical louvers, pleated window shades, business cards, point-of-purchase displays, book covers, menu covers, interior and exterior vehicle trim, picture frame mats, tags, greeting cards, baseball cards, scrapbooks, photo albums, dishes, trays, food containers, three-dimensional articles, pedestals, natural wood light diffusers, light panels, lampshades, candle luminaries, partitions, screens, place mats, floor mats, decorative appliqués, acid-free and/or photo-safe archival applications, inlays, and translucent inserts.

III. Transfer Media

In the present invention, a transfer image (e.g., comprising dye) is formed in any type of transfer media (e.g., a sheet of paper). Examples of materials that may be used as a transfer medium, include, but are not limited to, (1) materials that can be printed upon by a printer, (2) materials that will facilitate and withstand heat transfer temperatures, and (3) materials that will facilitate incorporation of dye into the surface material. In preferred embodiments, the transfer medium is standard bond paper. In other preferred embodiments, the transfer medium is high quality ink jet paper. However, the medium may be any paper, for example, any paper used with mechanical thermal printers, ink jet printers, and laser printers. Other materials, such as sheets of metal, plastic, or fabric may also be used. The use of transfer media is disclosed, for example, in U.S. Pat. No. 4,406,662 to Beran et al., U.S. Pat. Nos. 5,246,518, 5,248,363, 5,302,223 and 5,487,614 to Hale, U.S. Pat. Nos. 5,431,501, 5,522,317, 5,555,813, 5,575,877, 5,590,600, 5,601,023, 5,640,180, 5,642,141, 5,734,396, and 5,830,263 to Hale et al., U.S. Pat. No. 5,746,816 to Xu, and U.S. Pat. Nos. 5,488,907 and 5,644,988 to Xu et al, herein incorporated by reference in their entireties.

In the present invention, a transfer image comprising a dye may be applied to a transfer medium for subsequent heat transfer into a surface material. The dye may be applied to the transfer medium by any suitable means, including, but not limited to, computer-controlled devices such as mechanical thermal printers, ink jet printers, and laser printers. Thus, any digital image may be used including images of solid colors, patterned designs (e.g., woodgrain or marbled designs), and complex figures. The dye is printed at a temperature sufficient to apply the ink, but generally below the activation temperature of the dye. Generally, activation, or sublimation, of the dye does not take place at the time of printing the image on the medium, but occurs during the transfer from the medium to the surface material.

In some preferred embodiments, the dye is applied to the transfer medium by means of a computer-controlled liquid ink printing device, such as an ink jet printer. In some embodiments, a bubble jet printer is used. In other embodiments, a free flow ink jet printer is used. In yet other embodiments, a piezio electric ink jet printer is used. In some embodiments, the dye is applied to the transfer medium by means of a computer-controlled solid ink printing device, such as a phase change ink jet printer. In some embodiments, a ribbon printer is used. In some embodiments, the dye is applied to the transfer medium by means of a computer-controlled electrographic printing device, such as a laser printer or photocopier. The use of such a devices for applying a dye composition to a transfer medium is disclosed in U.S. Pat. Nos. 5,487,614 to Hale, 5,431,501, 5,522,317, 5,575,877, 5,601,023, 5,640,180, 5,642,141, 5,734,396, and 5,830,263 to Hale et al., 5,746,816 to Xu, and 5,488,907 and 5,644,988 to Xu et al.

Additional printing apparatuses contemplated under the present invention include, but are not limited to, products marketed by companies such as Brother (Bridgewater, N.J.), Canon (Lake Success, N.Y.), Encad (San Diego, Calif.), Epson (Long Beach, Calif.), Hewlett-Packard (Palo Alto, Calif.), Eastman Kodak (Rochester, N.Y.), Lexmark (Lexington, Ky.), Minolta (Ramsey, N.J.), Oki Data (Mt. Laurel, N.J.), Ricoh (West Caldwell, N.J.), and Xerox (Stamford, Conn.). Other preferred printers include, but are not limited to, EPSON STYLUS PRO, EPSON STYLUS PRO XL, EPSON STYLUS COLOR 3000, EPSON 800, EPSON 850, and EPSON 1520.

IV. Dyes

In some preferred embodiments, the composition used to create the transfer image is a dye that is produced from sublimation, dye diffusion, or heat sensitive dyes. Dye solids of small particle size, preferably 0.5 microns or less in diameter, are dispersed in a liquid carrier, and one or more agents are used to maintain what may be called, according to various definitions, a colloidal, dispersion or emulsion system. A particularly preferred composition is a liquid dye consisting of 0.05 to 20 percent by weight of one or more sublimation, dye diffusion, or heat sensitive dyes; 0.05 to 30 percent by weight of a dispersant and/or emulsifying agent; 0 to 45 percent by weight of one or more solvents or co-solvents; 0 to 15 percent by weight of one or more additives; and 40 to 98 percent by weight of water. Such compositions are disclosed in U.S. Pat. Nos. 5,640,180, 5,642,141, and 5,830,263 to Hale et al. (incorporated herein by reference in their entireties).

One preferred composition is a dye containing 5 to 30 percent by weight of one or more heat activated dyes; 1 to 20 percent by weight of an emulsifying enforcing agent; 0 to 30 percent by weight of a binder; 0 to 40 percent by weight of one or more humectants; 0 to 10 percent by weight of a foam control agent; 0 to 2 percent by weight of a fungicide; 0 to 10 percent by weight of a viscosity control agent; 0 to 10 percent by weight of a surface tension control agent; 0 to 10 percent by weight of a diffusion control agent; 0 to 15 percent by weight of a flow control agent; 0 to 20 percent by weight of an evaporation control agent; 0 to 10 percent by weight of a corrosion control agent; 0 to 30 percent by weight of a co-solvent; and 30 to 90 percent of a solvent, which may be water. Such compositions are disclosed in U.S. Pat. Nos. 5,488,907 to Xu et al. and 5,601,023 and 5,734,396 to Hale et al. (incorporated herein by reference in their entireties).

In some embodiments, the composition (e.g., ink) used to create the transfer image comprise a solid dye that comprises heat activated dyes, and a phase change material, or transfer vehicle, that will liquefy upon the application of heat to the ink composition. A polymer binder and additives may be added to the dye composition. A particularly preferred composition.is a solid ink containing 5 to 30 percent by weight of one or more heat activated dyes; 20 to 70 percent by weight of a transfer vehicle such as wax or a wax-like material; 1 to 20 percent by weight of an emulsifying enforcing agent; 0 to 30 percent by weight of a binder; 0 to 15 percent by weight of a plasticizer; 0 to 10 percent by weight of a foam control agent; 0 to 10 percent by weight of a viscosity control agent; 0 to 10 percent by weight of a surface tension control agent; 0 to 10 percent by weight of a diffusion control agent; 0 to 15 percent by weight of a flow control agent; 0 to 10 percent by weight of a corrosion control agent; and 0 to 5 percent of an antioxidant. Such compositions are disclosed in U.S. Pat. Nos. 5,488,907 to Xu et al. and 5,601,023 and 5,734,396 to Hale et al. (incorporated herein by reference in their entireties).

In some embodiments, the compositions used to create the transfer image are solid dyes that comprise heat activated dyes and a phase change material, or transfer vehicle, that will liquefy upon the application of heat to the dye composition. A polymer binder and additives may be added to the dye composition. A particularly preferred composition is a solid dye containing 5 to 30 percent by weight of one or more heat activated dyes; 30 to 70 percent by weight of a transfer vehicle such as wax or a wax-like material; 0 to 30 percent by weight of a binder; and 0 to 30 percent of one or more additives. Such compositions are disclosed in U.S. Pat. Nos. 5,302,223 and 5,487,614 to Hale, 5,431,501, 5,522,317, and 5,575,877 to Hale et al., and 5,644,988 to Xu et al. (incorporated herein by reference in their entireties).

In some embodiments, the compositions used to create the transfer image are liquid dyes that are produced from sublimation, dye diffusion, or heat sensitive dyes. The composition may comprise monomer or polymer materials in either solvent or emulsion form, an initiator or catalyst (which may be compounded into the inks so as to provide separation from the polymer), a surface tension control agent, a dispersing agent, a humectant, a corrosion inhibitor, a flow control aid, a viscosity stabilization aid, an evaporation control agent, a fungicide, an anti-foaming chemical, a fusing control agent, and antioxidants. A particularly preferred composition is a liquid ink containing of, in addition to inks or dyes, 10 to 20 percent by weight of a surface preparation material; 40 to 90 percent by weight of a solvent, 0 to 40 percent by weight of a co-solvent; and 0 to 30 percent by weight of one or more additives. Such compositions are disclosed in U.S. Pat. Nos. 5,487,614 to Hale, 5,431,501, 5,522,317, and 5,575,877 to Hale et al., and 5,644,988 to Xu et al. (incorporated herein by reference in their entireties).

In some embodiments, the dye composition used to create the transfer image is a liquid dye that is produced from sublimation, dye diffusion, or heat sensitive dyes. Dye solids of small particle size, no larger than 0.5 microns in diameter, preferably 0.1 microns or less in diameter, are dispersed in a liquid carrier, and one or more agents are used to maintain what may be called, according to various definitions, a colloidal, dispersion or emulsion system. A particularly preferred composition is a liquid ink containing 0.05 to 5 percent by weight of one or more sublimation, dye diffusion, or heat sensitive dyes; 0.05 to 40 percent by weight of a dispersant and/or emulsifying agent; 0 to 45 percent by weight of one or more solvents or co-solvents; 0 to 20 percent by weight of one or more additives; and 40 to 98 percent by weight of water. Such a composition is disclosed in U.S. Pat. No. 5,746,816 to Xu (incorporated herein by reference in its entirety).

In some embodiments, the dye composition used to create the transfer image is a dry toner composition that comprises heat activated dyes encased in a molecular sieve product, one or more binder polymers, and/or one or more charge control additives. A particularly preferred composition is a solid ink containing 3 to 20 percent by weight of a molecular sieve product containing one or more heat activated dyes; 50 to 90 percent by weight of one or more binder materials; and 0.5 to 10 percent of one or more charging additives. Such a composition is disclosed in U.S. Pat. Nos. 5,555,813 and 5,590,600 to Hale et al. (incorporated herein by reference in their entireties).

Additional dye and ink compositions and materials contemplated under the present invention include, but are not limited to, products marketed under the names ARTAINIUM UV+ (Tropical Graphics, Oakland Park, Fla.), SUBLIJET, SUBLIRIBBON, and SUBLITONER (Sawgrass Systems, Mt. Pleasant, S.C.), CELANOL, KEYCO DISPERSE, KEYMICRO, KEYSCREEN, KEYSPERSE, KEYSTONE, KEYTRANS, and SUBLAPRINT (Keystone Aniline Corporation, Chicago, Ill.), BAFIXAN and CELLITON (BASF A.G., Ludwigshafen, Germany), EASTMAN (Eastman Chemical Company, Kingsport, Tenn.), INTRATHERM (Crompton & Knowles Corporation, Stamford, Conn.), DIACELLITON, DIANIX, and DIARESIN (Mitsubishi Chemical Industries, Ltd., Tokyo, Japan), DYSTAR (DyStar Textilfarben GmbH & Co., Frankfurt, Germany), SUMIPLAST and SUMIKALON (Sumitomo Chemical Co., Ltd., Osaka, Japan), DISPERSOL, VYNAMON, and WAXOLINE (Imperial Chemical Industries Ltd., London, England), CATULIA (Francolor Company, Riefux, France) AUTOTOP, CIBACET, TERAPRINT, and TERASIL (Ciba-Geigy Corporation, Ardsley, N.Y.), OPLAS (Orient Chemical Industries, Ltd., Osaka, Japan), HOSTASOL and SAMARON (Hoechst AG, Frankfurt, Germany), ASTRAZON, CERES, MACROLEX, and RESOLIN (Bayer AG, Leverkusen, Germany), AIZEN (Hodogaya Chemical Co., Ltd., Japan), ORCOCILACRON and ORCOSPERSE (Organic Dyestuffs Corporation, Providence, R.I.), KAYACRYL, KAYALON, KAYANOL, AND KAYASET (Nippon Kayaku Co., Ltd., Tokyo, Japan), and MIKAZOL and MIKETON (Mitsui & Co., New York, N.Y.).

V. Printing Systems and Devices

The transfer images of the present invention are generally applied with heat and pressure. Any system or device that is capable of applying heat and/or pressure to a transfer medium containing a transfer image such that a fixed image is formed in a surface material is useful for practicing the present invention. In some embodiments, a heat transfer press is employed. The use of a heat transfer machine/device to transfer dyes from the transfer medium to the substrate is disclosed in U.S. Pat. Nos. 4,406,662 to Beran et al., 5,246,518, 5,248,363, 5,302,223 and 5,487,614 to Hale, 5,431,501, 5,522,317, 5,555,813, 5,575,877, 5,590,600, 5,601,023, 5,640,180, 5,642,141, 5,734,396, and 5,830,263 to Hale et al., 5,746,816 to Xu, and 5,488,907 and 5,644,988 to Xu et al. (herein incorporated by reference in their entireties).

Additional heat transfer apparatuses that may be employed with methods and systems of the present invention include, but are not limited to, products marketed by companies such as Geo Knight & Co. (Brockton, Mass.), Hix Corporation (Pittsburg, Kans.), and National Equipment (Pittsburg, Kans.).

In some preferred embodiments, a system or device that is capable of heating the surface material from at least two sides is employed. Such systems allow even heating of surface materials to be printed into.

Systems may also be employed with the present invention that combine heating components and pressure components, and that allow for large-scale production of surface materials with fixed images. These systems include, for example, kilns, roller type assembly lines, and transfer images on rolls that are applied as the surface material passes by. Experiments conducted during the development demonstrated that the printing methods of the present invention may be conducted for only a few seconds to obtain high quality images. Therefore, in some embodiments heated rollers are used to continuously print images into surface materials that are fed through the rollers, wherein the material need only contact the rollers for a few seconds to enable image transfer. In some such embodiments, the material fed through the rollers is preheated in a separate portion of the apparatus prior to being passed through the rollers for printing. Using such embodiments, the present invention provides methods for high throughput production of printed materials and for the printing of large sections of materials.

In some embodiments, a plurality of printing apparatuses of the present invention are provided in a single system (e.g., in a single facility) to allow high production levels of printed surface materials. In some such embodiments, two or more apparatuses or banks of apparatuses are controlled by a central control unit (e.g., a computer processor operably connected to the printing apparatuses). In some embodiments, large printing jobs (e.g., printing for architectural works) are carried out on multiple different printing devices, wherein each device is assigned a portion of the total project by the central control unit. In some embodiments, the central control unit also provides a system for labeling and/or tracking products (e.g., to facilitate shipment or delivery of products to customers). In still other embodiments, the central control unit provides, or is linked to a system that provides, order entry capabilities. For example, in some embodiments, a customer selects a pattern or provides a pattern to be printed to the central control unit and the pattern is printed into polymer materials for shipment to the customer. In some embodiments, the customer selects the pattern from a home computer or a computer in a retail store and the information is passed to the central control unit (e.g., located in a production facility) over a communication network (the Internet). Thus, the present invention allows customers to select any desired image (e.g., a digital photograph or artistic work) and transfer the image to a production facility to have the printed surface materials generated and shipped to the customer. Because the present invention provides, for the first time, the ability to print detailed, bright colored images into previously resistant surface materials, and because the present invention provides production capabilities, a new market for custom design products is created. In some preferred embodiments, many or all of the production steps are automated, allowing product ordering to product production to be carried out with little to no human intervention.

VI. Fixed Image Characteristics

The systems and methods of the present invention allow fixed images to be transferred into surface materials with high levels of dye transfer. The resulting fixed images have novel characteristics. One of these characteristics that is conveniently measured is optical density. The fixed images of the present invention have optical densities very close to the original transfer image's optical density, as well as very high optical density values in general.

Optical density may be determined by employing a gray scale. Another method for measuring optical density is with the aid of a densitometer or other conventional methods. For example, a densitometer may be employed to directly measure the optical density of a surface material with a fixed image. Alternatively, a digital photograph of a surface material with a fixed image may be printed out and then analyzed with a densitometer.

While the human eye is a very good comparison device (it can perceive density variations and compare them to a known calibrated standard that identifies specific density levels), it cannot, however, assign specific numerical values to those variations. A densitometer, on the other hand, can assign numbers to the density variations the eye perceives by quantifying the amount of light that is reflected from a surface material with a fixed image formed therein. The densitometer is used to measure the light that would normally be reflected from the surface and reach the eye. A minimum of reflected light results in a high density (in other words, the sample absorbs a good deal of light).

Densitometers are routinely used for quality control in printing. Measurements in printing are primarily concerned with the primary colors of cyan, magenta, yellow and black. The light emitted by the light source consists of the three light colors of red, green, and blue. Since the proportions of these three colors are approximately equal, we perceive this light as white light. The quantity of light received by the photo diode in a densitometer are converted into electricity, and the internal electronics compare this measured current with a reference value (e.g., white). The difference obtained is the basis for calculating the absorption characteristics of the image being measured.

Color filters in the ray path of the densitometer may be used to restrict the light to the wavelengths relevant for image or portion of the image being measured. Color filters possess the property of allowing their own color to pass through and absorbing or blocking the rays of other colors.

The high quality of the fixed images of the present invention may also be evaluated by comparing the original transfer image (e.g., color print out on high quality paper) with the final fixed image in the surface material. Surprisingly, the fixed images of the present invention closely resemble the original transfer image. In order to evaluate how close the fixed image is to the original transfer image, optical density measurement of the original transfer image and the fixed image may be obtained and compared. These optical density values may be from the fixed image and transfer images themselves, or a digital image of the fixed image and the transfer image may be obtained and then compared.

Comparing the optical density values from a transfer image and a fixed image may be done as simply as subtracting one value from the other. For example, if a transfer image has an optical density value of 2.2, and a fixed image has an optical density value of 2.0, one could simply subtract 2.0 from 2.2 to obtain 0.2 as the difference between the two values (i.e., the fixed image is within 0.2 of the transfer image in this example). Another way to make a quantitative comparison between the transfer image and the fixed image is to employ software to compare digital images of each. In this regard, the high quality of the fixed images of the present invention may be quantitatively compared to an original transfer image (e.g., a transfer image prepared by the same method as the transfer image used to make the fixed image).

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

We claim:

1. A method for printing an image onto a laminate material, comprising:
a) providing a laminate material and a transfer medium comprising a transfer image;
b) coating the laminate material with an acrylic resin to create a coated surface;
c) contacting said coated surface with said transfer medium such that a fixed image is formed in said coating to create a printed laminate.

2. The method of claim 1, further comprising the step of affixing said printed laminate to a rigid surface.

3. The method of claim 2, wherein said rigid surface comprises a wall.

4. The method of claim 2, wherein said rigid surface comprises the surface of furniture.

5. The method of claim 1, wherein said image is a high-resolution wood pattern.

6. The method of claim 5, wherein said high-resolution wood pattern appears as wood to the human eye at a distance of ten feet.

7. The method of claim 5, wherein said high-resolution wood pattern appears as wood to the human eye at a distance of five feet.
